(19) United States
(12) Patent Application Publication
(10) Pub. No.: US 2007/0071988 A1
(43) Pub. Date: Mar. 29, 2007

(54) Adhesive blends for styrene polymers and articles

(76) Inventor: Maged G. Botros, West Chester, OH (US)

Correspondence Address: WILLIAM A. HEIDRICH;Equistar Chemicals, LP, 11530 Northlake Drive, Cincinnati, OH, 45249, US

(21) Appl. No.: 11/238,568

(22) Filed: Sep. 29, 2005

(51) Int. Cl. B32B 27/08; B32B 27/30; B32B 27/32; B32B 25/14

(52) U.S. Cl. 428/515; 428/519; 428/520; 428/516; 428/517; 525/240

(57) ABSTRACT

Tie-layer adhesives for styrene polymer resins are provided. The adhesive blend compositions are comprised of ethylene-vinyl acetate copolymer, styrene-butadiene-styrene triblock copolymer, ethylene-propylene rubber and graft-modified polyethylene.

### BACKGROUND OF THE INVENTION

1. Field of the Invention

The invention relates to improved tie-layer adhesive blend compositions and their use for coextruded multi-layer films and sheets having one or more styrene polymer layers. The adhesive blends are comprised of ethylene-vinyl acetate copolymer, styrene-butadiene-styrene triblock copolymer, ethylene-propylene rubber and graft-modified polyethylene.

2. Description of the Prior Art

Multi-layer films and sheets are widely used in the packaging industry for food packing applications. Depending on the intended end-use application, the number and arrangement of resin layers and the type of resins employed will vary.

Polyethylene (PE) resins are often included as one of the layers for their food contact and sealing properties. Ethylene-vinyl alcohol (EVOH) copolymers and polyamides (nylons) are widely used as barrier layers to prevent the passage of oxygen and moisture. Styrene polymers are commonly included as structural layers. Styrene polymers which contain rubber, such as high impact polystyrene (HIPS), are especially useful for this purpose.

A continuing problem within the industry is how to adhere the dissimilar resin layers within such multi-layer constructions. Tie-layer adhesive compositions containing modified, i.e., functionalized, polyolefins are widely used for this purpose. While numerous tie-layer adhesive resins are available which can effectively adhere PE to EVOH or polyamides, adhesion to styrene resins is problematic.

It would be highly advantageous if adhesive blends which provided superior adhesion to styrene polymers without sacrificing adhesion to other polymer types employed in multi-layer constructions were available. These and other advantages are obtained with the ethylene-vinyl acetate (EVA)-based adhesive blends of the invention.

The use of EVA and modified EVA adhesive formulations is known. For example, U.S. Pat. No. 4,576,995 to Nakabayashi, et al., discloses adhesives useful for bonding EVOH copolymer and polystyrene to produce laminates having enhanced gas barrier properties. The adhesives are modified EVA copolymers obtained by graft-copolymerizing a styrenic vinyl monomer and an alpha, beta-unsaturated carboxylic acid to an EVA copolymer.

Japanese Application No. 53018653 (reported in Derwent Abstract No. 26079A/14) describes low temperature heat sealing adhesives consisting of carboxylated EVA copolymer and petroleum resins.

Japanese Application No. 58203043 (reported in Derwent Abstract No. 84-008480/02) discloses adhesives for bonding polystyrene which are blends of polystyrene or styrene-butadiene copolymer resin, EVA copolymer and a grafted polyolefin.

Japanese Application No. 59055743 discloses adhesive blends comprised of EVA copolymer graft-modified with unsaturated carboxylic acid or anhydride, EVA copolymer graft-modified with e.g., styrene, aromatic vinyl compounds and/or non-grafted EVA or other ethylene polymer.

U.S. Pat. No. 4,861,676 discloses extrudable adhesive blends of graft-modified ethylene copolymer, polystyrene and saturated alicyclic hydrocarbon resin. The graft-modified ethylene polymer can be EVA and unmodified EVA can also be included inn the formulation. Styrene-butadiene triblock copolymers can be used provided the copolymer contains higher styrene levels. Styrene contents of 80 to 90% are disclosed to be suitable.

U.S. Pat. No. 4,058,647 discloses laminated resin products wherein a polyolefin layer and barrier layer are firmly bonded without the use of an adhesive layer. The modified polyolefin contains a rubber component, which can be a styrene-butadiene rubber (SBR).

U.S. Pat. No. 5,070,143 discloses blends of polyolefins, which can include EVAs, a grafted component and, optionally, an elastomeric material such as EPR. The graft component can include block copolymers of styrene. U.S. Pat. No. 5,597,865 also discloses the use of a functionalized, i.e., grafted, styrene block copolymer in combination with EVA or ethylene/acrylate copolymers and an impact-modified polystyrene. Styrene block copolymers which are grafted are styrene-ethylenelbutylene-styrene (SEBS) copolymers.

U.S. Pat. No. 5,709,953 discloses adhesive compositions comprised of an ethylene polymer fraction and styrene/aliphatic/styrene triblock elastomer fraction. The ethylene polymer fraction can contain graft-modified polyolefin. Whereas the polyethylene component can include EVA copolymers, the reference teaches the VA preferably be kept below 10 wt. %, more preferably below about 2 wt. % and, most preferably, 0 wt. %. Furthermore, the reference does not disclose the use of ethylene-propylene rubbers with the styrene elastomer.

There is a continuing need for adhesive compositions which provide improved adhesion to styrene polymer layers in coextruded multi-layer films and sheets comprised of one or more of these layers. This and other benefits are realized with the compositions of the present invention.

### SUMMARY OF THE INVENTION

The invention relates tie-layer adhesive blends. More specifically, the invention relates to tie-layer compositions useful to adhere styrene resins comprised of 30 to 55 wt. %, based on the total weight of the composition, ethylene-vinyl acetate copolymer having a vinyl acetate content from 10 to 30 wt. %; 18.5 to 32.5 wt. %, based on the total weight of the composition, styrene-butadiene-styrene triblock polymer containing from 40 to 47.5 wt. % bound styrene; 0.5 to 20 wt. %, based on the total weight of the composition, ethylene-propylene rubber or ethylene-propylene-diene rubber containing greater than 50 wt. % ethylene; and 0.5 to 25 wt. %, based on the total weight of the composition, graft-modified polyethylene. Particularly useful adhesive blends are those wherein the ethylene-vinyl acetate copolymer has a vinyl acetate content from 12 to 28 wt. %; the styrene-butadiene-styrene triblock polymer contains from 42.5 to 45 wt. % bound styrene; the ethylene-propylene rubber or ethylene-propylene diene rubber contains 60 wt. % or more ethylene; and the graft-modified polyethylene is an ethylene-α-olefin copolymer grafted with 0.5 to 3 wt. % ethylenically unsaturated carboxylic acid or acid derivative and, more particularly, those blends wherein the ethylene-vinyl acetate copolymer has a vinyl acetate content from 15 to 20 wt. % and constitutes 32.5 to 52.5 wt. % of the adhesive composition; the styrene-butadiene-styrene triblock polymer contains less than 1 wt. % diblock and constitutes 20 to 30 wt. % of the adhesive composition; the ethylene-propylene rubber or ethylene-propylene-diene rubber constitutes 3 to 18 wt. % of the adhesive composition; and the graft-modified polyethylene is an HDPE or LLDPE copolymer resin grafted with maleic anhydride and constitutes 2.5 to 20 wt. % of the adhesive composition.

Also disclosed are coextruded multi-layer films or sheets comprising a styrene polymer layer and tie-layer adhesively bonded. The multi-layer constructions may further comprise polyolefin and ethylene-vinyl alcohol copolymer layers. The tie-layer adhesives are particularly useful for bonding polystyrene, high impact polystyrene and mixtures of polystyrene and high impact polystyrene.

### DETAILED DESCRIPTION

The improved adhesive blends of the invention suitable for use as tie-layers for multi-layer constructions containing one or more styrene polymer layers are comprised of EVA copolymer, styrene-butadiene-styrene triblock copolymer, ethylene-propylene rubber and graft-modified polyethylene.

The ethylene-vinyl acetate (EVA) copolymer component comprises 30 to 55 weight percent (wt. %) of the adhesive composition. More preferably, the EVA constitutes 32.5 to 52.5 wt. % of the adhesive blend and in a particularly advantageous embodiment of the invention, the EVA is present from 35 to 50 wt. %. All weight percentages provided herein for the adhesive blend components are based on the total weight of the composition.

The EVA component can consist of a single EVA copolymer or a blend of two or more EVA copolymers. The VA content, i.e., wt. % of vinyl acetate copolymerized, of the EVA component can range from 10 to 30 wt. %; more preferably from 12 to 28 wt. %; and most preferably from 15 to 20 wt. %. In a highly useful embodiment of the invention, the EVA component is comprised of a single EVA resin having a VA content of 15-20 wt. % or a mixture of said EVA with a lower VA content EVA. In the latter case where a mixture of EVAs is employed, the high VA content EVA constitutes 60% or more of the mixture and the VA content of the low VA content EVA can be less than 10% provided the total VA content of the mixed EVA-component is within the previously recited ranges.

The styrene-butadiene-styrene (SBS) triblock elastomer is utilized in sufficient amount so that the styrene blocks promote excellent adhesion to polystyrene substrates. Typically, the SBS triblock component comprises 18.5 to 32.5 wt. % of the adhesive blend composition. More preferably, the SBS component is present in the range 20 to 30 wt. %. Whereas SBS triblock polymers having styrene contents from about 40 to 47.5 wt. % can be employed, it is particularly advantageous to utilize SBS triblock polymers containing 42.5 to 45 wt. % bound styrene. It is even more advantageous when the SBS triblock component contains less than 1 wt. % diblock. SBS triblock elastomeric products useful for the invention are commercially available.

Ethylene-propylene rubber (EPR) and/or ethylene-propylene-diene rubber (EPDM) are included in the formulations of the invention. These elastomers typically contain greater than 50 wt. % ethylene. EPRs or EPDMs containing 60 wt. % or more ethylene are particularly advantageous. Elastomeric products of this type are obtained by conventional polymerization procedures known to the art and include the so-called metallocene rubbers. Illustrative elastomers of the above type obtainable from commercial sources include BUNA EPT 2070 (22 Mooney ML(1+4)125° C., 69% ethylene), BUNA EPT 2370 (16 Mooney, 3% ethylene norbornene, 72% ethylene), BUNA 2460 (21 Mooney, 4% ethylene norbornene, 62% ethylene), KELTAN EPDM DE244 (Mooney 55, 71% ethylene, 0.2% ethylene norbornene) and NORDEL IP 3720P (20 Mooney; 69% ethylene; 0.5% ethylene norbornene).

The EPR and/or EPDM component constitutes 0.5 to 20 wt. % of the adhesive composition. More preferably, the EPR or EPDM component is present in an amount from 3 to 18 wt. % and, most preferably, from 5 to 15 wt. %.

Graft-modified polyolefins blended with the above-described components to obtain the improved adhesive blends of the invention are polyethylene resins and, more particularly, ethylene homopolymers and copolymers, grafted with an ethylenically unsaturated carboxylic acid or acid derivative. Mixtures of two or more modified ethylene polymers may be employed for preparation of the adhesive blends. Copolymers of ethylene and butene-1, hexene-1 or octene-1 obtained utilizing known polymerization processes, including metallocene and single-site polymerization processes and grafted with maleic anhydride, are most commonly used.

Grafting is accomplished in accordance with known procedures, generally by heating a mixture of the polyethylene and graft monomer(s) with or without a solvent. Most typically, the grafted products are prepared by melt blending the polyethylene in the substantial absence of a solvent with the grafting monomer in a shear-imparting extruder/reactor. Twin screw extruders such as those marketed by Coperion (formerly Werner-Pfleiderer) under the designations ZSK-53, ZSK-83, ZSK-90 and ZSK-92 are especially useful for carrying out the grafting operation. A free radical generating catalyst, such as an organic peroxide, can be employed but is not necessary.

Carboxylic acids and carboxylic acid derivatives utilized as grafting monomers can include compounds such as acrylic acid, maleic acid, fumaric acid, citraconic acid, mesaconic acid, maleic anhydride, 4-methyl cyclohex-4-ene-1,2-dicarboxylic acid or anhydride, bicyclo(2.2.2)oct-5-ene-2,3-dicarboxylic acid or anhydride, bicyclo(2.2.1)hept-5-ene-2,3-dicarboxylic acid or anhydride, tetrahydrophthalic acid or anhydride, methylbicyclo(2.2.1) hept-5-ene-2,3-dicarboxylic acid or anhydride, and the like. Acid anhydride derivatives which can be used to graft the polyethylene include dialkyl maleates, dialkyl fumarates, dialkyl itaconates, dialkyl mesaconates, dialkyl citraconates and alkyl crotonates. It may be desirable to use more than one grafting monomer to vary the physical properties of the modified polyolefin product. Maleic anhydride (MAH) is a particularly useful grafting monomer.

Modified PEs derived from ethylene-α-olefin copolymers having densities from 0.905 to 0.965 g/cm³ and grafted with 0.5 to 3 wt. % ethylenically unsaturated carboxylic acid or acid derivative are particularly useful for preparation of the improved adhesive blend compositions of the invention. In one highly useful embodiment, the ethylene-α-olefin copolymer is an HDPE resin having a density from about 0.945 to 0.965 g/cm³. In another highly useful embodiment, the ethylene-α-olefin copolymer is a LLDPE resin having a density from about 0.910 to 0.930 g/cm³. The LLDPE may be the same type as used for the base resin. Particularly useful adhesive blends are obtained using HDPE and LLDPE resins grafted with 0.75 to 2.5 wt. % maleic anhydride. The MI of the grafted HDPE or LLDPE component will most generally be in the range from about 0.5 to about 20 g/10 min.

The graft-modified PE component constitutes from 0.5 up to about 25 wt. % of the adhesive blend. More preferably, the graft-modified PE is present in an amount such that it comprises 2.5 to 20 wt. % of the adhesive blend. In an especially useful embodiment, the graft component comprises 5 to 17.5 wt. % of the blend and is maleic anhydride grafted HDPE or LLDPE.

The adhesive blends of the invention may be prepared by physically mixing and melt blending the essential components plus any additional components or additives by any convenient means. Melt blending using a Banbury mixer or extruder is especially convenient.

Compositions of the invention find utility in forming composite structures, e.g., films and sheets, by adhering a layer of the adhesive to one or more substrates by any convenient means, and by coextrusion in particular. Substrates of particular interest include layers of polyolefins such as polyethylene, polar substrates such as EVOH and polyamides and any of the wide variety of styrene polymers, including homopolymers and copolymers. The styrene polymers may be but are need not necessarily modified by the inclusion of an elastomer. Impact-modified polystyrene substrates are of particular interest due to their utility as structural layers in multilayer laminate structures.

High impact polystyrene (HIPS) resin compositions are commonly used for multi-layer laminate coextrusion. These resins, i.e., HIPS, contain up to about 30 wt. % and, more typically, between about 10 and about 15 wt. % of an elastomer. Suitable elastomers for use as impact modifiers in styrene resin compositions include natural rubber and synthetic rubbers, such as styrene-butadiene rubber, acrylonitrile-butadiene rubber, butyl rubber, chloroprene rubber, silicone rubber, acryl rubber, urethane rubber, polybutadiene rubber, ethylene propylene rubber, etc. In high impact polystyrene resin compositions, the elastomer exists as a dispersed phase in the styrene polymer.

One advantage of the invention is its excellent adhesion under a variety of conditions to non-polar polyolefins, polar polymers and HIPS substrates in particular. The resulting composite structures are easily formed and can be readily die cut after thermoforming.

Composite structures of the above types, and particularly those of the structure PE/adhesive/EVOH/adhesive/styrene resin, have utility for the fabrication of refrigerator liners and food packaging such as thermoformed cups, flexible sheets, cast or blown films, cast sheets, etc. Particularly advantageous structures are those wherein the PE is HDPE or low density polyethylene (LDPE) and the styrene resin is polystyrene, HIPS or mixtures of polystyrene and HIPS.

The following examples illustrate the invention; however, those skilled in the art will recognize numerous variations which are within the spirit of the invention and scope of the claims. Adhesive tie-layer blend compositions utilized in the examples were pelletized prior to use. This was accomplished by dry blending all of the components and then melt blending the mixture in a Warner-Pfleiderer ZSK-30 twin screw extruder equipped with a multi-hole (⅛ inch diameter) die connected to a strand cutter. The extruder screw speed was 250 rpm. Temperatures in the extruder ranged from 180° C. to 200° C. Melt temperature at the extruder die was 209° C.

To evaluate adhesion of the tie-layer compositions, 24 mil multi-layer cast sheets were prepared. The five-layer coextruded sheets had an A/B/C/B/A layer structure where B represents the tie-layer composition, C represents EVOH and A represents polystyrene layers. The sheets were produced on a Killion laboratory scale film line using three 1 inch extruders in an A/B/C/B/A feedblock configuration. Sheets were extruded using a 10 inch flat die to produce continuous 8 inch wide samples.

Adhesion values reported herein were determined in accordance with ASTM D 1876-93. Tie-layer/styrene polymer adhesion values reported are the average of the values obtained at both tie-layer/styrene interfaces since it was observed that, for the 24 mil sheet, adhesion on the side which contacted the chill roll was slightly higher. EVOH/tie-layer adhesion was determined after separation and removal of the styrene polymer layers. Separation at only one EVOH/tie-layer interface was possible due to the thinness of the remaining structure.

### EXAMPLE 1

Multi-layer coextruded sheet having the following construction and weight percentage of each component was prepared:

| | | | | |
|---|---|---|---|---|
| 43% | 4% | 6% | 4% | 43% |
| Styrene Polymer | Tie-layer | EVOH | Tie-layer | Styrene polymer |

The EVOH was a commercial resin obtained from Nippon Gohsei and contained 32 mole percent ethylene. The styrene polymer was a 50:50 mixture of polystyrene and high impact polystyrene (HIPS). The tie-layer adhesive obtained in accordance with the invention was comprised of 48.83 wt. % EVA (VA content 18%); 25 wt. % SBS triblock copolymer (44.5% bound styrene; <1% diblock); 10 wt. % EPDM (Mooney viscosity 20; 69% ethylene; 0.5% ethylidenenorbornene); and 16 wt. % HDPE grafted with 1.9% maleic anhydride. The adhesive blend also contained 0.17 wt. % of a commercial hindered phenol stabilizer.

Temperatures in the three heating zones and at the die for each of the three extruders used to coextrude the 5-layer sheet were as follows:

| | |
|---|---|
| Polystyrene | 360° F./405° F./420° F./425° F. |
| EVOH | 380° F./380° F./400° F./455° F. |
| Tie-Layer | 355° F./400° F./410° F./455° F. |

Adhesion at the tie-layer/styrene polymer interface was 1.13 lbs/in. Adhesion at the tie-layer/EVOH interface was 1.36 lbs/in.

### COMPARATIVE EXAMPLE A

To demonstrate the markedly superior adhesion to styrene polymers obtained with the compositions of the invention, Example 1 was repeated. The tie-layer adhesive used for this comparative example utilized the same amount of a different styrene tri-block polymer. The triblock polymer used was a styrene-isoprene-styrene triblock (VECTOR 4111A). All other components used for the comparative adhesive blend were the same and used in the same amounts as reported in Example 1. Whereas adhesion at the tie-layer/EVOH interface obtained with the comparative adhesive blend was comparable to that obtained in Example 1 (1.40 lbs/in versus 1.36 lbs/in), adhesion at the tie-layer/styrene polymer interface obtained with the comparative blend was only 0.12 lbs/in—nearly 10 times less than obtained with the adhesive blend of the invention.

### EXAMPLE 2

To demonstrate the ability to vary the formulation of the invention and to utilize a mixture of EVA resins, five-layer sheet was prepared in accordance with the procedure of Example 1. The styrene polymer and EVOH utilized to form the 5-layer coextruded sheet were the same as used in Example 1. The tie-layer adhesive used contained 38.83 wt. % EVA (VA content 18%) and 10 wt. % EVA (VA content 9%); 25 wt. % SBS triblock copolymer; 10 wt. % EPDM; 16 wt. % graft-modified HDPE; and 0.17 wt. % hindered phenol stabilizer. All of the components used, except for the EVA, were the same as in Example 1.

Adhesion at the tie-layer/styrene polymer interface was 0.30 lbs/in and adhesion at the tie-layer/EVOH interface was 1.50 lbs/in. The adhesive blend was also demonstrated to have good heat sealability at various temperatures. For example, when a 5-mil film of the adhesive blend was heat sealed to a 5-mil film of a 50/50 HIPS/polystyrene blend at 40 psi for 3 seconds, adhesion values of 0.35 and 1.0 lbs/in were obtained at sealing temperatures of 450° F. and 500° F., respectively. Similar results were observed when heat sealing the adhesive blend film to a 75/25 HIPS/polystyrene film.

### COMPARATIVE EXAMPLE B

To demonstrate the improved adhesion to styrene polymers obtained with the composition of the invention and the need to utilize a SBS triblock polymer, Example 2 was repeated except that 25 wt. % styrene-isoprene-styrene triblock polymer was substituted for the SBS. Adhesion at the tie-layer/EVOH interface obtained with the comparative adhesive blend was comparable to that obtained in Example 2 (1.48 lbs/in versus 1.50 lbs/in); however, adhesion at the tie-layer/styrene polymer interface using the comparative blend was significantly lower (0.13 lbs/in for the comparative blend versus 0.30 lbs/in for the adhesive blend of the invention).

### COMPARATIVE EXAMPLE C

To demonstrate the need to utilize an ethylene-propylene rubber component, an adhesive composition was prepared utilizing a mixture of EVA resins. The adhesive blend contained 39.83 wt. % EVA (VA content 28%) and 10 wt. % EVA (VA content 9%); 25 wt. % SBS triblock copolymer; 20 wt. % graft-modified HDPE maleic anhydride and 5 wt. % plastomer (EXACT 8201). Plastomers of this type, i.e., derived using metallocene technology, have been shown to enhance adhesion in tie-layer formulations containing maleic anhydride grafted polyolefins. The adhesive blend also contained 0.17 wt. % of hindered phenol stabilizer.

Extruder conditions utilized to prepare the 24 mil coextruded sheet as well as the styrene and EVOH resins were the same as used in Example 2. Adhesion at the tie-layer/styrene polymer interface obtained using the comparative adhesive blend was only 0.15 lbs/in—only half that achieved using the adhesive blend of Example 2.

I claim:

1. An adhesive composition comprising:
(a) 30 to 55 wt. %, based on the total weight of the composition, ethylene-vinyl acetate copolymer having a vinyl acetate content from 10 to 30 wt. %;
(b) 18.5 to 32.5 wt. %, based on the total weight of the composition, styrene-butadiene-styrene triblock polymer containing from 40 to 47.5 wt. % bound styrene;
(c) 0.5 to 20 wt. %, based on the total weight of the composition, ethylene-propylene rubber or ethylene-propylene-diene rubber containing greater than 50 wt. % ethylene; and
(d) 0.5 to 25 wt. %, based on the total weight of the composition, graft-modified polyethylene.

2. The adhesive composition of claim 1 wherein the ethylene-vinyl acetate copolymer has a vinyl acetate content from 12 to 28 wt. %.

3. The adhesive composition of claim 2 wherein the ethylene-vinyl acetate copolymer has a vinyl acetate content from 15 to 20 wt. % and constitutes 32.5 to 52.5 wt. % of the adhesive composition.

4. The adhesive composition of claim 1 wherein the styrene-butadiene-styrene triblock polymer contains from 42.5 to 45 wt. % bound styrene.

5. The adhesive composition of claim 4 wherein the styrene-butadiene-styrene triblock polymer contains less than 1 wt. % diblock and constitutes 20 to 30 wt. % of the adhesive composition.

6. The adhesive composition of claim 1 wherein the ethylene-propylene rubber or ethylene-propylene diene rubber contains 60 wt. % or more ethylene and constitutes 3 to 18 wt. % of the adhesive composition.

7. The adhesive composition of claim 1 wherein the graft-modified polyethylene is an ethylene-α-olefin copolymer grafted with 0.5 to 3 wt. % ethylenically unsaturated carboxylic acid or acid derivative.

8. The adhesive composition of claim 7 wherein the graft-modified polyethylene is HDPE or LLDPE copolymer resin grafted with maleic anhydride and constitutes 2.5 to 20 wt. % of the adhesive composition.

9. A multi-layer film or sheet comprising a styrene polymer layer and a tie-layer adhesively bonded thereto, said tie-layer comprising an adhesive composition comprising 30 to 55 wt. %, based on the total weight of the composition, ethylene-vinyl acetate copolymer having a vinyl acetate content from 10 to 30 wt. %; 18.5 to 32.5 wt. %, based on the total weight of the composition, styrene-butadiene-styrene triblock polymer containing from 40 to 47.5 wt. % bound styrene; 0.5 to 20 wt. %, based on the total weight of the composition, ethylene-propylene rubber or ethylene-propylene-diene rubber containing greater than 50 wt. % ethylene; and 0.5 to 25 wt. %, based on the total weight of the composition, graft-modified polyethylene.

10. The multi-layer film or sheet of claim 9 wherein the styrene polymer is selected from the group consisting of polystyrene, high impact polystyrene and mixtures of polystyrene and high impact polystyrene.

11. The multi-layer film or sheet of claim 10 wherein the ethylene-vinyl acetate copolymer has a vinyl acetate content from 12 to 28 wt. %; the styrene-butadiene-styrene triblock polymer contains from 42.5 to 45 wt. % bound styrene; the ethylene-propylene rubber or ethylene-propylene diene rubber contains 60 wt. % or more ethylene; and the graft-modified polyethylene is an ethylene-α-olefin copolymer grafted with 0.5 to 3 wt. % ethylenically unsaturated carboxylic acid or acid derivative.

12. The multi-layer film or sheet of claim 11 wherein the ethylene-vinyl acetate copolymer has a vinyl acetate content from 15 to 20 wt. % and constitutes 32.5 to 52.5 wt. % of the adhesive composition; the styrene-butadiene-styrene triblock polymer contains less than 1 wt. % diblock and constitutes 20 to 30 wt. % of the adhesive composition; the ethylene-propylene rubber or ethylene-propylene-diene rubber constitutes 3 to 18 wt. % of the adhesive composition; and the graft-modified polyethylene is an HDPE or LLDPE copolymer resin grafted with maleic anhydride and constitutes 2.5 to 20 wt. % of the adhesive composition.

13. The multi-layer film or sheet of claim 10 comprising a further polyolefin layer and wherein the tie-layer is disposed between the polyolefin layer and the styrene polymer layer.

14. The multi-layer film or sheet of claim 13 wherein the polyolefin layer is HDPE or LDPE.

15. The multi-layer film or sheet of claim 10 comprising a further layer of ethylene-vinyl alcohol copolymer and wherein the tie-layer is disposed between the ethylene-vinyl alcohol copolymer layer and the styrene polymer layer.
